(19) United States
(12) Patent Application Publication
(10) Pub. No.: US 2025/0128328 A1
(43) Pub. Date: Apr. 24, 2025

(54) AN INTEGRATED SYSTEM AND METHOD FOR IN-SITU LASER PEENING OF A THREE-DIMENSIONAL PRINTED PART

(71) Applicant: Sunrise International, Inc., Marietta, GA (US)

(72) Inventors: Keith T. Glover, Dublin, OH (US); Stanley C. Bovid, Dublin, OH (US); Michael A. Kattoura, Columbus, OH (US)

(21) Appl. No.: 18/689,975

(22) PCT Filed: Sep. 8, 2022
(86) PCT No.: PCT/US2022/076120

§ 371 Date: Mar. 7, 2024

Related U.S. Application Data
(60) Provisional application No. 63/241,695, filed on Sep. 8, 2021.

(51) Int. Cl. B22F 10/64; B22F 10/28; B23K 26/356; B33Y 40/20; C21D 10/00

(52) U.S. Cl. CPC B22F 10/64; B23K 26/356; B33Y 40/20; C21D 10/005; B22F 10/28

(57) ABSTRACT

A method is provided for in-situ laser shock peening of a three-dimensional printed metal part.

### CROSS REFERENCE TO RELATED APPLICATIONS

This application claims the benefit of U.S. Provisional Application No. 63/241,695, filed on Sep. 8, 2021, which is incorporated by reference herein in its entirety.

### BACKGROUND

Traditionally, complex parts made of metals and alloys (e.g., stainless steel, aluminum, titanium, nickel, etc.) have been fabricated by machining from a metal block or by casting. More recently, however, the manufacture of metallic parts by three-dimensional (“3D”) printing has been made possible by direct melting metal or alloy powders with binding agents layer-by-layer, such as by direct metal laser sintering (“DMLS”), selective laser sintering (“SLS”), selective laser melting (“SLM”), and electron beam melting (“EBM”), or alternatively through wire-fed electric-arc deposition, wherein metallic wires (instead of metal powder with binding agents) are fused layer-over-layer. While metal parts made from 3D printing may exhibit superior strength, superior ductility, and require shorter prototyping and design test cycles than traditional machined parts, 3D printed metal parts, especially from metal powder, are often highly porous on a microscopic level and, consequently, are more prone to fatigue-related damage when under stress.

### SUMMARY

Laser shock peening, also known as “laser peening” and “LSP,” a substitute or complementary process for traditional shot peening, is a cold working process used to produce a deep (e.g., ≥1 mm) compressive residual stress layer and modify mechanical properties of materials by impacting the material with enough force to create plastic deformation. The residual stresses created by the LSP process increase a material's resistance to fatigue and stress and thereby significantly increase the life of laser peened parts. LSP uses high energy laser pulses to generate a plasma plume and cause a rapid rise of pressure on the surface of a part. This pressure creates and sustains a high-intensity shockwave, which propagates into the surface of the part. The shockwave generated by LSP induces cold work into the microstructure of the part material and contributes to the increased performance of the part. As the shockwave travels into the part, some of the energy of the wave is absorbed during the plastic deformation of the part material. This is also known as cold working. To improve tensile strength (i.e., less tendency to deform or to fracture) of a 3D printed metal part, in-situ LSP (“IS-LSP”), as disclosed herein, may be performed on the 3D printed metal part.

A method for IS-LSP of a 3D printed metal part may include the steps of: executing by a processor program code stored in a memory to synchronize 3D printing of a metal part and LSP of the metal part, wherein the synchronizing may include: printing by a 3D printing apparatus a metal layer according to dimensions specified in a 3D printing program, wherein the printing of the metal layer includes depositing one of a metal or alloy wire feed and metal or alloy powder and direct melting layer-by-layer the deposited metal or alloy wire feed or the deposited metal or alloy powder using an electric arc or a laser beam; and IS-LSP by a first laser beam generating apparatus the 3D printed metal part, wherein the IS-LSP includes performing one or both of: (a) IS-LSP a partially finished printed metal part in progress during the 3D printing process to form an internal peened grid framework at a plurality of metal layer deposition locations, and (b) IS-LSP a finished printed metal part upon completion of the 3D printing process.

The IS-LSP of a 3D printed metal part may be performed by an integrated system, which may include a controller comprising a processor that executes program code stored in a memory to control and synchronize 3D printing of a metal part and IS-LSP of the metal part, wherein the integrated system includes: a 3D printing apparatus configured to print a metal layer of the 3D printed metal part, one layer at a time, according to dimensions specified in a 3D printing program; the integrated system further includes either one of: an electric arc generating apparatus configured to generate an electric arc to directly melt layer-by-layer the printed metal layer deposited by a metal or alloy wire feed, and a second laser beam generating apparatus configured to generate a laser beam to directly melt layer-by-layer the printed metal layer deposited either by the metal or alloy wire feed or by metal or alloy powder, and a first laser beam generating apparatus configured to perform IS-LSP of the 3D printed metal part, wherein the first laser beam generating apparatus is further configured to perform one or both of: (a) IS-LSP a partially finished printed metal part in progress during the 3D printing process to form an internal peened grid framework at a plurality of metal layer deposition locations, and (b) IS-LSP a finished printed metal part upon completion of the 3D printing process.

### BRIEF DESCRIPTION OF THE FIGURES

FIG. 1A is a schematic diagram of an integrated system for IS-LSP of a 3D printed metal part at a same metal layer deposit location and at other selected locations.

FIG. 1B is a schematic diagram of an integrated system for IS-LSP of a 3D printed metal part at selected locations other than a deposit location.

FIG. 2 is a flow chart depicting examples of methods to perform IS-LSP of a 3D printed metal part.

FIG. 3 is an example of a robotic arm mounted with an open surface optical head for IS-LSP of a 3D printed metal part.

FIG. 4A is an example of an open surface optical head for IS-LSP of a 3D printed metal part.

FIG. 4B is an example of a robotic arm mounted with an open surface optical head for IS-LSP of a 3D printed metal part.

FIG. 5 is an example of IS-LSP of friction stir welding between 3D printed metal parts.

FIG. 6 is an example of IS-LSP of an interior surface of a 3D printed metal part.

FIG. 7 is an example of IS-LSP of a metal layer surface during a 3D printing process.

FIG. 8 is an example of IS-LSP of both interior and exterior surfaces of a finished metal tank made by a 3D printing process.

### DETAILED DESCRIPTION

The disclosure is better understood with reference to the following drawings and description. The elements in the figures are not necessarily to scale, emphasis instead being placed upon illustrating the principles of the disclosure. Moreover, in the figures, like-referenced numerals may designate corresponding parts throughout the different views. Furthermore, unless otherwise stated, additional elements may intervene after an output pulsed laser beam.

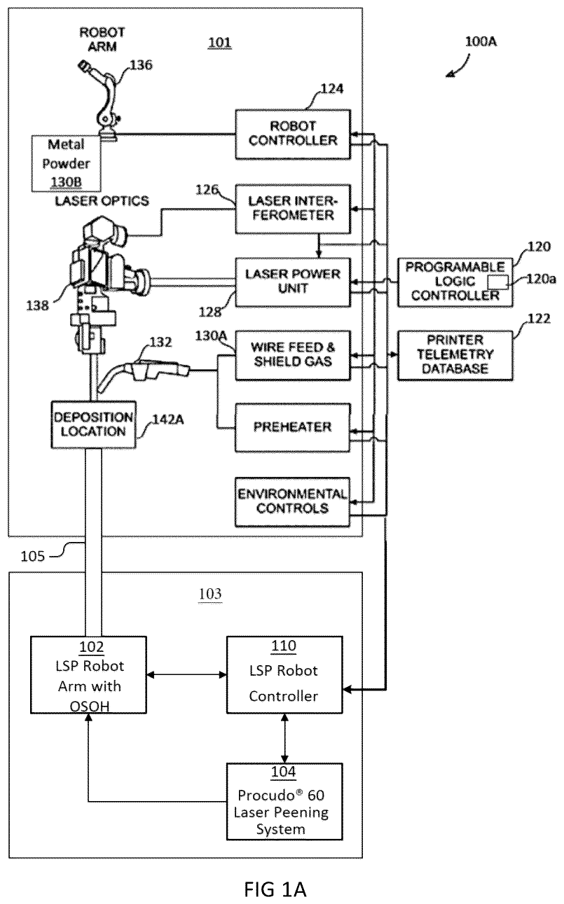

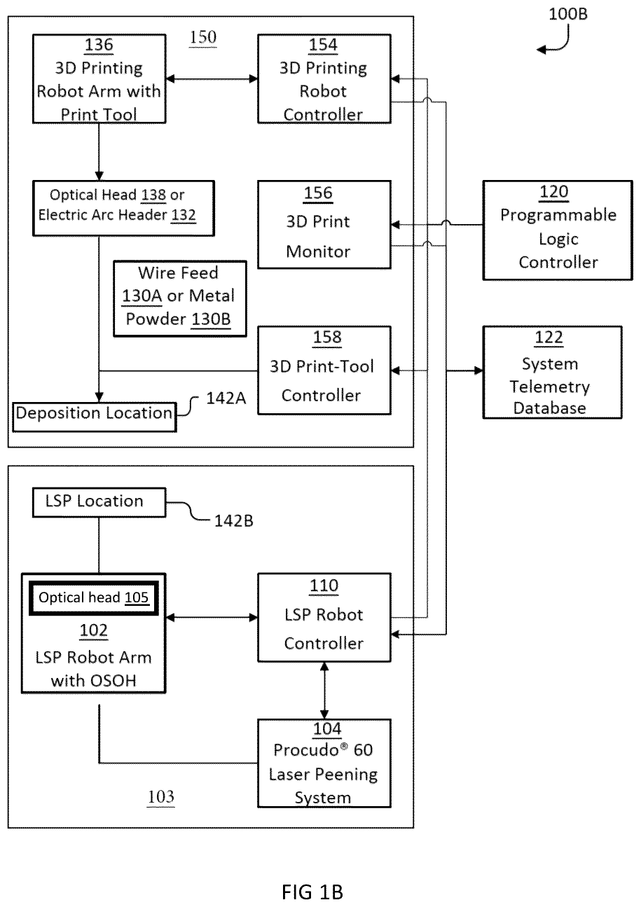

FIGS. 1A and 1B are schematic diagrams of similar integrated systems for an IS-LSP of a 3D printed metal part. More specifically, the integrated system in FIG. 1A uses a laser beam or an electric arc to perform direct melting of a metal layer after depositing, wherein IS-LSP may be performed on the same deposition location 142A of the melted metal layer (i.e., IS-LSP while 3D printing is in progress) to form a peened grid framework at a plurality of metal layer deposition locations, in addition to performing IS-LSP on other selected locations, such as on an exterior surface and/or an interior surface of a finished 3D printed metal part.

The integrated system in FIG. 1B, however, may use the same integrated system of FIG. 1A (i.e., using a laser beam or electric arc melting method), except that the IS-LSP may be performed on a selected location 142B, which may not be the same as the deposit location 142A. For example, the selected location 142B for the IS-LSP may be on any other surface of the finished 3D printed metal part, including an exterior and/or an interior surface of a finished 3D printed metal part, other than the deposition location of the metal layer 142A during the 3D printing.

With further reference to FIG. 1A, the integrated system 100A may include a controller 120 having a processor 120a that executes program code stored in a memory to control and synchronize performing 3D printing of a metal part and performing IS-LSP of the metal part, wherein the integrated system 100A may include: a 3D printing apparatus 101 configured to print a metal layer of the 3D printed metal part, one layer at a time, at a metal layer deposition location 142A according to dimensions specified in a 3D printing program 122. In the integrated system 100A, an electric arc generating apparatus 132 is configured to generate an electric arc to directly melt layer-by-layer the printed metal layer deposited by a metal or alloy wire feed 130A at the metal layer deposition location 142A. Alternately, a second laser beam generating apparatus 128 is configured to generate a laser beam to directly melt layer-by-layer the printed metal layer deposited either by the metal or alloy wire feed 130A or by metal or alloy powder 130B at the deposition location 142A of the 3D printed metal part in the 3D metal part printing process.

In the system 100A, a first laser beam generating apparatus 103 may be configured to perform IS-LSP of the 3D printed metal part at a same deposition location 142A or a different deposition location 142B, wherein the first laser beam generating apparatus 103 may be further configured to perform one or both of: (a) IS-LSP a partially finished printed metal part in progress during the 3D printing process (including at the deposition location 142A) to form an internal peened grid framework, and (b) IS-LSP a finished printed metal part at a position different from the deposition location 142B (i.e., one or both of an interior and/or exterior surface) upon completion of the 3D printing process.

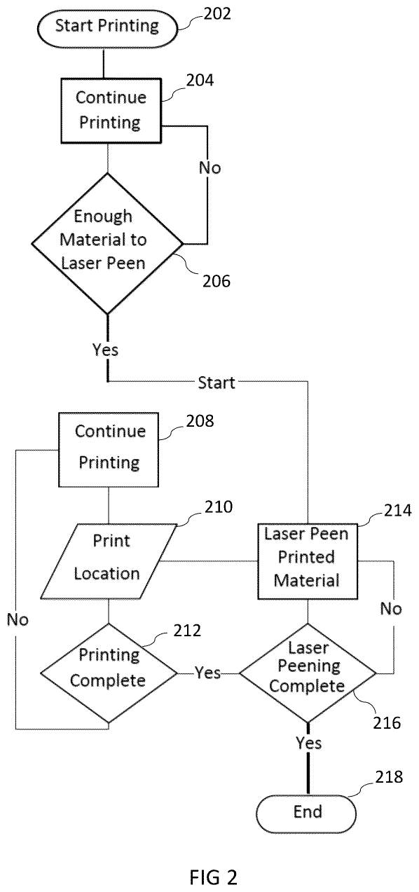

FIG. 2 is a flow chart depicting examples of different methods to perform IS-LSP of a 3D printed metal part. In step 202, a processor 120a may execute program code stored in a memory to synchronize performing 3D printing (see steps 204 to 212) of a metal part and performing IS-LSP (see steps 214 to 218) of the metal part.

In step 204, a 3D printing apparatus 101 deposits a layer of metal wire from a wire feed 130A or metal powder 130B and prints a 3D structure layer-by-layer of a metal part at a metal layer deposition location 142A according to dimensions specified in a 3D printing program. Each deposited printed layer of metal may be followed by a direct melting process by either one of: an electric arc generating apparatus 132 configured to generate an electric arc to directly melt layer-by-layer the printed metal layer deposited by the metal or alloy wire feed 130A, and a second laser beam generated by a second laser beam generating apparatus 128 to directly melt layer-by-layer the printed metal layer deposited either by the metal or alloy wire feed 130A or by metal or alloy powder 130B of the 3D printed metal part in the 3D metal part printing process. In an example, the direct melting of the metal powder layer by the laser beam may use any one of several direct melting methods, such as: DMLS, SLS, SLM, and EBM.

In an example, the metal powder layer may be a metal powder mixed with a polymer binding agent for homogeneous and uniform dispensing by a printer dispensing nozzle, wherein the metal powder may include metal or alloy in powder form selected from one of a metal or an alloy including: aluminum, stainless steel, tungsten, and titanium. Other metal or alloy powders may be used in this 3D printing process.

In step 206, a laser interferometer 143 may measure a metal layer thickness of the printed layer at the deposition location 142A to check if the metal thickness has reached a minimum thickness or the required thickness suitable for IS-LSP. In another example, the metal layer thickness may be pre-determined by the 3D printing program through the printer dispensing nozzle determination.

In step 208 and 210, if the metal layer thickness has not reached the requirement, the 3D printing process continues to repeat depositing a next metal layer at the deposition location 142A, followed by the direct melting of the next metal layer over a previously direct melted metal layer, according to the dimensions specified in the 3D structure of the metal part, until the 3D metal part is completed according to the 3D printing program in step 212.

In step 214, if the metal layer thickness has reached the minimum thickness or the specified thickness requirement predefined in the 3D printing program, IS-LSP (at the same metal layer deposition location 142A) of the 3D printed metal part may be performed by a first laser beam generating apparatus 103, wherein the IS-LSP may further include performing one or both of: (a) IS-LSP (at the same deposition location 142A) a partially finished printed metal part in progress during the 3D printing process to form an internal framework of peened grid at a plurality of metal layer deposition locations 142A, and (b) IS-LSP a finished printed metal part (at selected locations 142B, such as a surface or an entire surface, interior and/or exterior surfaces) upon completion of the 3D printing process.

In an example, IS-LSP of the partially finished printed metal part in progress may be repeated through steps 216 until completion. For example, the IS-LSP peening may repeat only after the direct melted layer of the metal part has exceeded a defined minimum thickness, or spaced apart IS-LSP may be performed at a defined distance between each successive peening throughout the entire 3D printing process. In an example, the defined minimum thickness may be measured from one of: (i) a start of the 3D printing process before a first LSP, and (ii) a prior in-situ laser shock peened layer since the start of the 3D printing process. Thus, performing an optional synchronizing IS-LSP during the 3D printing process on the partially finished printed metal part in progress may provide additional strength to an internal structure of the metal part by forming an internal framework of peened grids which are spaced apart by defined spacing according to the printing program at the plurality of metal layer deposition locations 142A.

In step 218, IS-LSP may terminate when the LSP has completed on the finished 3D printed metal part.

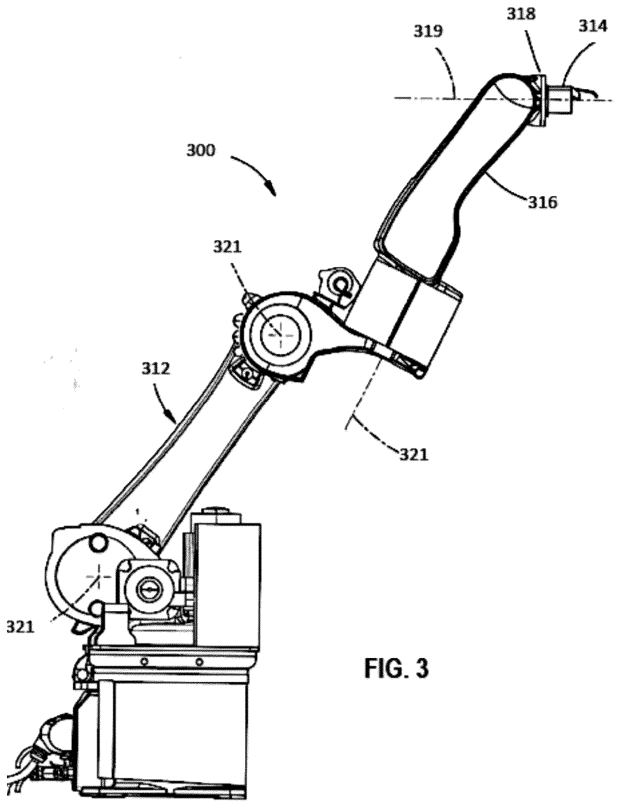

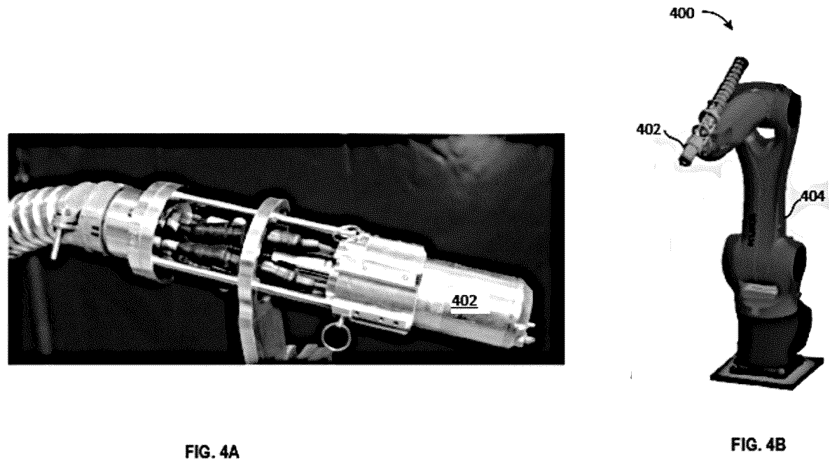

In an example, the direct melting of the deposited metal powder layer and the IS-LSP of the direct melted metal layer may be carried out using either the electric arc generation apparatus or the dedicated laser optics and dedicated laser beam generation apparatuses, such as using the second laser optics 138 of the second laser beam generation apparatus 128, either of which is dedicated only for the direct melting of the metal layer in the 3D printing process. The IS-LSP uses first laser optics 105 (also see 314 in FIGS. 3 and 402 in FIG. 4A) of the first laser beam generation apparatus 103, which are dedicated only for the IS-LSP of the printed metal part.

In an example, the dedicated second laser optics 138 and dedicated laser beam generation apparatuses 128, and the electric arc header 132 may be mounted on a respective second robotic arm 136 of the second laser beam generation apparatus 128 and the first laser optics 105 and a first robotic arm 102 of the first laser beam generation apparatus 103, respectively.

Alternately, separate dedicated laser optics (138, 105) and separate laser beam generation apparatuses (128, 103) may be eliminated by configuring the first laser optics 105 of the first beam generation apparatus 103 to consolidate functioning as a common laser optics and a common laser beam generation apparatus through generating and emitting respective characteristics of laser beams (i.e., to output a CW laser beam or a pulsed laser beam) to perform both the direct melting (e.g., CW laser beam) of the metal powder layer in the 3D metal part printing process and followed by the IS-LSP (e.g., pulsed laser beam) of the printed metal part in progress.

FIG. 3 depicts an example of the first laser optics 105 (which may be configured to be the common laser optics), which may be an open surface optical head 314 (see FIG. 3) mounted on a first robotic arm 300 of the first laser beam generation apparatus 103 (which may be configured to be the common laser beam generation apparatus), wherein the first robotic arm 300 may have six or more degrees of freedom of movement formed by a combination of linear axis 319 and a plurality of rotational axes 321 for performing the direct melting (CW laser beam) of the layer of deposited metal powder during the 3D printing and the IS-LSP (pulsed laser beam) of the partially finished or the completely finished metal part.

FIG. 4 depicts another example of the second laser optics 105 (which may be configured to be the common laser optics) as an open surface optical head 402 (see FIG. 4A), which may be mounted on a robotic arm 404 (see FIG. 4B) of the first laser beam generation apparatus 103 (which may be configured to be the common laser beam generation apparatus), wherein the robotic arm 404 having a combination of linear and a plurality of rotational axes for performing the direct melting of the layer of deposited metal layer during the 3D printing and the IS-LSP (pulsed laser beam) of the partially finished or the completely finished metal part.

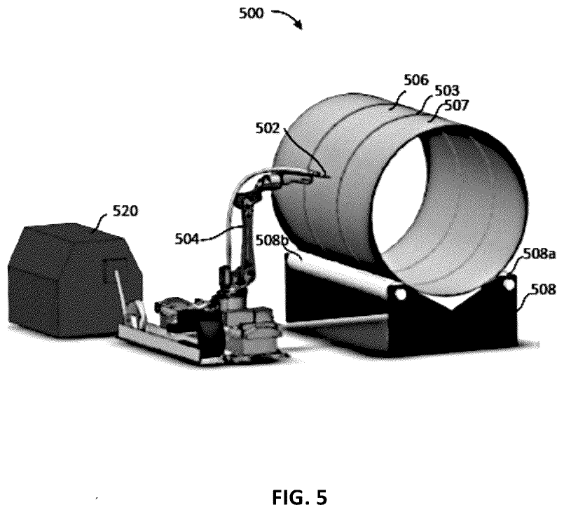

FIG. 5 is an example of friction stir welding to join between 3D printed metal parts. Referring to FIG. 5, it is shown that separate partially finished 3D printed metal parts 506, 507 or the completely finished 3D printed metal parts may be joined to form a larger 3D printed metal part 500 through friction stir welding, and wherein the friction stir welded joint 503 may be strengthened through performing IS-LSP on the joint 503 to improve joint strength.

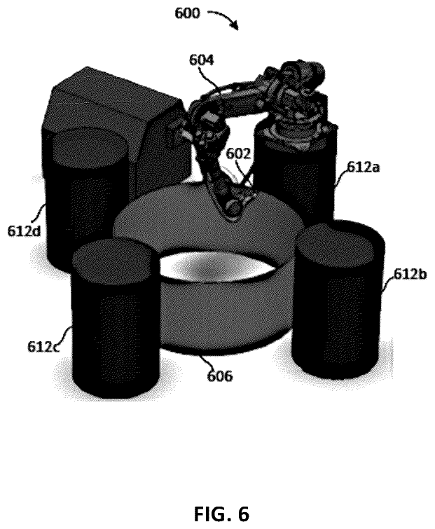

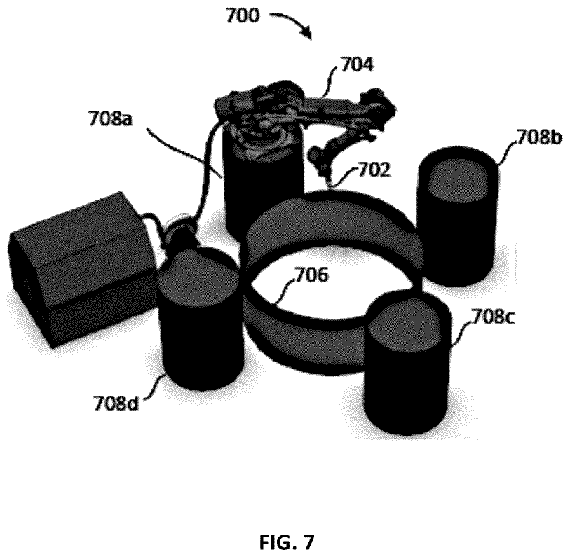

FIG. 5-7 depict different examples of IS-LSP of the partially finished or completed 3D printed metal parts, by manipulating the respective second laser optics 502, 602, 702 mounted on the respective second robotic arm 504, 604, 704 to perform the IS-LSP of one or both of an interior surface 606, an exterior surface 506, or a melted metal layer surface 706 of the partially finished or finished 3D printed metal part (such as a tube, a tank, a panel, a sheet, a blade, or any 3D structures).

FIG. 5-7 also depict different examples of IS-LSP of the partially finished or completed 3D printed metal parts which may be disposed on different pedestals 508, 612a-612d, 708a-708d to facilitate positioning of the metal part for LSP.

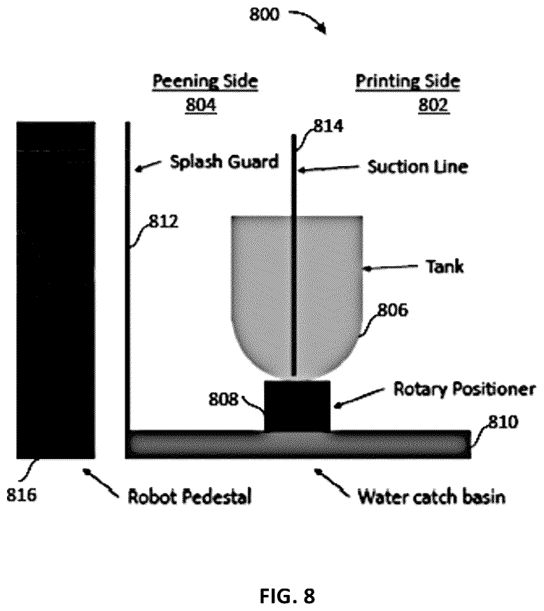

FIG. 8 is an example of IS-LSP of both interior and exterior surfaces of a finished metal tank made by 3D printing process. In an example, a water system may be bonded or electrically connected as ground to the partially or completely finished printed metal part to eliminate electrical potential differences, wherein the water system may include a splash guard 812 and a collection system 810 to protect an operator from injury by directly exposed to the laser beam and from electrical shock.

This application incorporates by reference the content of International Application No. PCT/US21/42730, titled “Laser Shock Peening Apparatus,” filed on Jul. 22, 2021, U.S. Provisional Application No. 63/055,017, filed on Jul. 22, 2020, and U.S. Provisional Application No. 63/164,599, filed on Mar. 23, 2021.

While the systems, methods, and apparatuses have been illustrated by describing example embodiments, and while the example embodiments have been described and illustrated in considerable detail, it is not the intention of the applicants to restrict, or in any way limit, the scope of the appended claims to such detail if such detail is not recited in the claims. It is, of course, not possible to describe every conceivable combination of components or methodologies for purposes of describing the systems, methods, and apparatuses. With the benefit of this application, additional advantages and modifications will readily appear to those skilled in the art. Therefore, the invention, in its broader aspects, is not limited to the specific details and illustrative example and example embodiments shown and described. Accordingly, departures may be made from such details without departing from the spirit or scope of the general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

What is claimed is:

1. A method for in-situ laser shock peening of a three-dimensional (3D) printed metal part, the method comprising:
executing by a processor program code stored in a memory to synchronize 3D printing of a metal part and in-situ laser shock peening of the metal part, wherein the synchronizing comprises performing one or both of:
printing by a 3D printing apparatus a metal layer according to dimensions specified in a 3D printing program, wherein the printing of the metal layer comprises depositing one of: a metal or alloy wire feed and metal or alloy powder;
direct melting layer-by-layer the deposited metal or alloy wire feed, or the deposited metal or alloy powder, using an electric arc or a laser beam, the 3D printed metal layer in the 3D metal part printing process, and
in-situ laser shock peening by a first laser beam generating apparatus the 3D printed metal part, wherein the in-situ laser shock peening further comprises performing one or both of:
(a) in-situ laser shock peening a partially finished printed metal part in progress during the 3D printing process to form an internal peened grid framework at a plurality of metal layer deposition locations, and
(b) in-situ laser shock peening a finished printed metal part upon completion of the 3D printing process.

2. The method according to claim 1, wherein the 3D printing of the metal part comprises:
configuring the 3D printing apparatus to deposit the metal layer, one layer at a time according to dimensions specified in a 3D structure of the metal part stored in a printing program;
direct melting by one of: an electric arc generated by an electric arc generation apparatus and a laser beam generated by a second laser beam generating apparatus, the deposited metal layer; and
repeat depositing a next metal layer followed by the direct melting of the next metal layer over a previously direct melted metal layer, according to the dimensions specified in the 3D printing program of the metal part, until the metal part is completed.

3. The method according to claim 2, wherein the direct melting of the metal layer by the laser beam uses one of direct melting methods comprising: direct metal laser sintering (DMLS), selective laser sintering (SLS), selective laser melting (SLM), and electron beam melting (EBM).

4. The method according to claim 2, wherein the in-situ laser shock peening of the partially finished printed metal part in progress during the 3D printing process takes place only after the direct melted layer of the metal part by the electric arc or by the laser beam has exceeded a defined minimum thickness, and wherein the defined minimum thickness is measured from one of: (i) a start of the 3D printing process before a first laser shock peening, and (ii) a prior laser shock peened layer since the start of the 3D printing process.

5. The method according to claim 2, wherein the direct melting by the laser beam of the deposited metal layer and the in-situ laser shock peening of the direct melted metal layer are carried out by one of:
(a) first laser optics of the first laser beam generation apparatus dedicated only for the in-situ laser shock peening of the printed metal part, second laser optics of the second laser beam generation apparatus dedicated only for the direct melting of the metal layer in the 3D printing process, and
(b) the first laser optics of the first beam generation apparatus being common laser optics and a common laser beam generation apparatus that emits respective characteristics of laser beams for the direct melting of the metal layer in the 3D printing process and for the in-situ laser shock peening of the printed metal part.

6. The method according to claim 5, wherein:
(a) each of the first laser optics and the electric arc header or second laser optics is mounted on a respective dedicated first and a second robotic arm of the first laser beam generation apparatus and the electric arc generation apparatus or the second laser beam generation apparatus, respectively, wherein each of the first and the second robotic arm has a combination of linear and a plurality of rotational axes for performing respectively, the in-situ laser shock peening of the partially finished or the completely finished metal part or the direct melting of the layer of deposited metal layer during the 3D printing; and
(b) the common laser optics comprise an open surface optical head which is mounted on the first robotic arm as a common robotic arm of the common laser beam generation apparatus, wherein the common robotic arm has a combination of linear and a plurality of rotational axes for performing respectively, the direct melting of the layer of deposited metal layer during the 3D printing and the in-situ laser shock peening of the partially finished or the completely finished metal part.

7. The method according to claim 1, wherein the metal or alloy powder to be deposited as the metal layer for direct melting comprises the metal or alloy powder mixed with a polymer binding agent for homogeneous and uniform dispensing by a printer nozzle, wherein the metal or alloy powder comprises one of: aluminum, stainless steel, tungsten, and titanium.

8. The method according to claim 6, wherein the in-situ laser shock peening comprises manipulating the respective first or common laser optics mounted on the first or common robotic arm to perform the in-situ laser shock peening of one or a combination of: the melted metal layer during the 3D printing process an interior surface or an exterior surface of the partially finished or finished 3D printed metal part.

9. The method according to claim 1, further comprising:
performing friction stir welding to join separate partially finished metal parts or completely finished 3D printed metal parts to form a larger 3D printed metal part, and
performing in-situ laser shock peening on the friction stir welded joint to improve welded joint strength.

10. The method according to claim 9, comprising electrically bonding the partially finished or completely finished 3D printed metal part to a water system to eliminate electrical potential differences, wherein the water system comprises a splash guard and a collection system to protect an operator from injury by being exposed to the laser beam and from electrical shock.

11. An integrated system for in-situ laser shock peening of a three-dimensional (3D) printed metal part, the system comprising:
a controller comprising a processor that executes program code stored in a memory to control and synchronize 3D printing of a metal part and in-situ laser shock peening of the metal part, wherein the integrated system comprising:
a 3D printing apparatus configured to print a metal layer of the 3D printed metal part, one layer at a time, according to dimensions specified in a 3D printing program;
the integrated system further comprising either one of:
an electric arc generating apparatus configured to generate an electric arc to directly melt layer-by-layer, the printed metal layer deposited by a metal or alloy wire feed, and
a second laser beam generating apparatus configured to generate a laser beam to directly melt layer-by-layer the printed metal layer deposited either by the metal or alloy wire feed or by metal or alloy powder of the 3D printed metal part in the 3D metal part printing process; and
a first laser beam generating apparatus configured to perform in-situ laser shock peening of the 3D printed metal part, wherein the first laser beam generating apparatus is further configured to perform one or both of:
(a) in-situ laser shock peening a partially finished printed metal part in progress during the 3D printing process to form an internal peened grid framework at a plurality of metal layer deposition locations, and
(b) in-situ laser shock peening a finished printed metal part upon completion of the 3D printing process.

12. The integrated system according to claim 11, wherein:
the second laser beam generating apparatus is configured to generate a respective laser beam to directly melt the deposited metal layer; and
the 3D printing apparatus and the electric arc generating apparatus or the first laser beam generating apparatus are synchronized to repeat depositing a next metal layer followed by the direct melting of the next metal layer over a previously direct melted metal layer, according to the dimensions specified in the 3D printing program of the metal part, until the metal part is completed.

13. The integrated system according to claim 12, wherein the direct melting of the metal layer by the laser beam uses one of direct melting methods comprising: direct metal laser sintering (DMLS), selective laser sintering (SLS), selective laser melting (SLM) and electron beam melting (EBM).

14. The integrated system according to claim 12, wherein the in-situ laser shock peening of the partially finished printed metal part in progress during the 3D printing process takes place only after the direct melted layer of the metal part by the electric arc or by the laser beam has exceeded a defined minimum thickness, and wherein the defined minimum thickness is measured from one of: (i) a start of the 3D printing process before a first laser shock peening, and (ii) a prior laser shock peened layer since the start of the 3D printing process.

15. The integrated system according to claim 12, wherein the direct melting by the laser beam of the deposited metal powder layer and the in-situ laser shock peening of the direct melted metal layer are carried out by one of:
(a) first laser optics of the first laser beam generation apparatus dedicated only for the in-situ laser shock peening of the printed metal part, second laser optics of the second laser beam generation apparatus dedicated only for the direct melting of the metal layer in the 3D printing process, and
(b) the first laser optics of the first beam generation apparatus being common laser optics and a common laser beam generation apparatus that emits respective characteristics of laser beams for the direct melting of the metal powder layer in the 3D printing process and for the in-situ laser shock peening of the printed metal part.

16. The integrated system according to claim 15, wherein:
(a) each of the first laser optics and the electric arc header or second laser optics is mounted on a respective dedicated first and a second robotic arm of the first laser beam generation apparatus and the electric arc generation apparatus or the second laser beam generation apparatus, respectively, wherein each of the first and the second robotic arm has a combination of linear and a plurality of rotational axes for performing respectively, the in-situ laser shock peening of the partially finished or the completely finished metal part or the direct melting of the layer of deposited metal layer during the 3D printing; and
(b) the common laser optics comprises an open surface optical head which is mounted on the first robotic arm as a common robotic arm of the common laser beam generation apparatus, wherein the common robotic arm having a combination of linear and a plurality of rotational axis for performing respectively, the direct melting of the layer of deposited metal layer during the 3D printing and the in-situ laser shock peening of the partially finished or the completely finished metal part.

17. The integrated system according to claim 12, wherein the metal or alloy powder to be deposited as the metal layer direct melting comprises metal or alloy powder mixed with a polymer binding agent for homogeneous and uniform dispensing by a printer nozzle, wherein the metal or alloy powder comprises on of: aluminum, stainless steel, tungsten, titanium.

18. The integrated system according to claim 16, wherein the in-situ laser shock peening comprises manipulating the respective first or common laser optics mounted on the first or common robotic arm to perform the in-situ laser shock peening of one or a combination of: the melted metal layer during the 3D printing process, an interior surface or an exterior surface of the partially finished or finished 3D printed metal part.

19. The integrated system according to claim 11, wherein the partially finished or the completely finished printed metal parts are joined to form a larger 3D printed metal part through friction stir welding, and wherein in-situ laser shock peening is performed on the friction stir welded joint connecting the partially finished or completely finished 3D printed metal parts to improve joint strength.

20. The integrated system according to claim 19, wherein the partially finished or completely finished 3D printed metal part is electrically bonded to a water system to eliminate electrical potential differences, wherein the water system comprises a splash guard and a collection system to protect an operator from injury by being exposed to the laser beam and from electrical shock.
